(19) United States
(12) Patent Application Publication
(10) Pub. No.: US 2012/0159527 A1
(43) Pub. Date: Jun. 21, 2012

(54) SIMULATED GROUP INTERACTION WITH MULTIMEDIA CONTENT

(75) Inventors: Kathryn Stone Perez, Kirkland, WA (US); Avi Bar-Zeev, Redmond, WA (US)

(73) Assignee: MICROSOFT CORPORATION, Redmond, WA (US)

(21) Appl. No.: 12/970,855

(22) Filed: Dec. 16, 2010

(51) Int. Cl. H04H 60/33; H04N 7/173

(52) U.S. Cl. 725/10; 725/93

(57) ABSTRACT

A method and system for generating time synchronized data streams based on a viewer's interaction with a multimedia content stream is provided. A viewer's interactions with a multimedia content stream being viewed by the viewer are recorded. The viewer's interactions include comments provided by the viewer, while viewing the multimedia content stream. Comments include text messages, audio messages, video feeds, gestures or facial expressions provided by the viewer. A time synchronized commented data stream is generated based on the viewer's interactions. The time synchronized commented data stream includes the viewer's interactions time stamped relative to a virtual start time at which the multimedia content stream is rendered to the viewer. One or more time synchronized data streams are rendered to the viewer, via an audiovisual device, while the viewer views a multimedia content stream.

### BACKGROUND

Video on demand (VOD) systems allow users to select and watch multimedia content on demand by streaming content through a set-top box, computer or other device. Video on demand systems typically provide users with the flexibility of viewing multimedia content at any time. However, users may not feel that they are a part of a live event or experience while watching recorded video content, video-on-demand content or other on-demand media content, since the content is typically streamed offline to the users. In addition, users may lack a sense of community and connectedness while watching multimedia content on demand, since they may not have watched the content live with their friends and family.

### SUMMARY

Disclosed herein is a method and system that enhances a viewer's experience while watching recorded video content, video-on-demand content or other on-demand media content by re-creating for the viewer, an experience of watching the multimedia content live with other users, such as the viewer's friends and family. In one embodiment, the disclosed technology generates multiple time synchronized data streams that include comments provided by the viewer and other users, such as the viewer's friends and family while the viewer views a multimedia content stream. Comments may include text messages, audio messages, video feeds, gestures or facial expressions provided by the viewer and other users. The time synchronized data streams are rendered to a viewer, via an audiovisual device, while the viewer views a multimedia content stream thereby re-creating for the viewer an experience of watching the multimedia content live with other users. In one embodiment, multiple viewers view a multimedia content stream in a single location and interactions with the multimedia content stream from the multiple viewers are recorded.

In another embodiment, a method for generating a time synchronized commented data stream based on a viewer's interaction with a multimedia content stream is disclosed. A multimedia content stream related to a current broadcast is received. A viewer is identified in a field of view of a capture device connected to a computing device. The viewer's interactions with the multimedia content stream being viewed by the viewer are recorded. A time synchronized commented data stream is generated based on the viewer's interactions. A request from the viewer to view one or more time synchronized commented data streams related to the multimedia content stream being viewed by the viewer is received. The time synchronized commented data streams are displayed to the viewer, via the viewer's audiovisual device, in response to the viewer's request.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates one embodiment of a target recognition, analysis and tracking system for performing the operations of the disclosed technology.

FIG. 2 illustrates one embodiment of a capture device that may be used as part of the tracking system.

FIG. 3 illustrates an embodiment of an environment for implementing the present technology.

FIG. 4 illustrates an example of a computing device that may be used to implement the computing device of FIGS. 1-2.

FIG. 5 illustrates a general purpose computing device which can be used to implement another embodiment of the computing device of FIGS. 1-2.

FIG. 6 is a flowchart describing one embodiment of a process for generating a time synchronized commented data stream based on a viewer's interactions with a multimedia content stream.

FIG. 6A is a flowchart describing one embodiment of a process for receiving commented data streams generated by other users, upon a viewer's request to view the commented data streams.

FIG. 6B is a flowchart describing one embodiment of a process for generating a time synchronized commented data stream.

FIG. 7 is a flowchart describing one embodiment of a process for generating a report of time synchronized commented data streams related to a specific multimedia content stream viewed by one or more users.

FIG. 8 is a flowchart describing one embodiment of a process for providing commented data streams generated by other users to a viewer based on the viewer's comment viewing eligibility.

FIG. 9A illustrates an exemplary user-interface screen for obtaining a viewer's preference information prior to recording the viewer's interaction with the multimedia content stream.

FIG. 9B illustrates an exemplary user-interface screen for obtaining a viewer's input to view comments from other users.

FIG. 10 illustrates an exemplary user-interface screen that displays one or more options to a viewer to view time synchronized commented data streams related to a multimedia content stream.

FIGS. 11A and 11B illustrate exemplary user-interface screens in which one or more time synchronized commented data streams related to a multimedia content stream are displayed to a viewer.

### DETAILED DESCRIPTION

Technology is disclosed by which a user's experience while watching recorded video content, video-on-demand content or other on-demand media content is enhanced. A viewer views a multimedia content stream related to a current broadcast via an audiovisual device. The viewer's interactions with the multimedia content stream are recorded. In one approach, the viewer's interactions with the multimedia content stream may include comments provided by the viewer in the form of text messages, audio messages or video feeds, while the viewer views the multimedia content stream. In another approach, the viewer's interactions with the multimedia content stream may include gestures, postures or facial expressions performed by the viewer, while the viewer views the multimedia content stream. A time synchronized commented data stream is generated based on the viewer's interactions. The time synchronized commented data stream is generated by synchronizing the data stream containing the viewer's interactions relative to a virtual start time of the multimedia content stream. In one embodiment, the time synchronized commented data stream is rendered to the viewer, via the audiovisual device, while simultaneously recording the viewer's interactions with the multimedia content stream. In another embodiment, one or more time synchronized commented data streams generated by other users is rendered to the viewer via the audiovisual device, upon the viewer's request, while simultaneously recording the viewer's interactions with the multimedia content stream.

Multiple data streams can be synchronized with one multimedia content stream and identified by user comment. In this manner, a group may be defined based on the data streams associated with the multimedia content. Viewers and users who provide their reactions and comments at different viewing times and places are thus brought together on subsequent viewings of the multimedia content as data associated with the content is added during each viewing in accordance with the technology. The group can be expanded from a viewer's friends to the viewer's social graph and beyond.

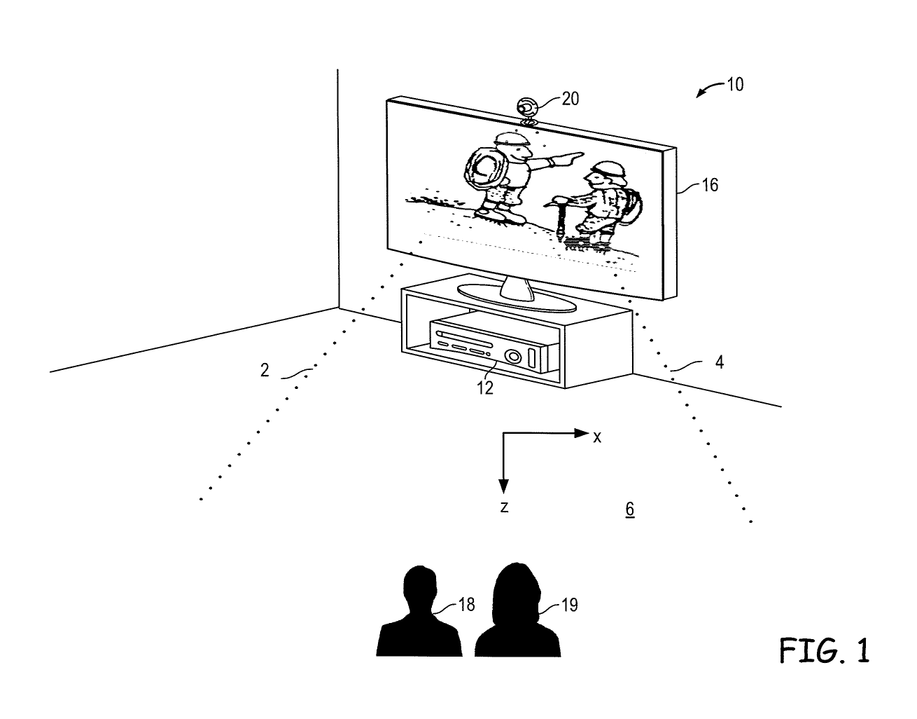

FIG. 1 illustrates one embodiment of a target recognition, analysis and tracking system 10 (generally referred to as a motion tracking system hereinafter) for performing the operations of the disclosed technology. The tracking system 10 may be used to recognize, analyze, and/or track one or more human targets such as users 18 and 19. As shown in FIG. 1, the tracking system 10 may include a computing device 12. In one embodiment, computing device 12 may be implemented as any one or a combination of a wired and/or wireless device, as any form of television client device (e.g., television set-top box, digital video recorder (DVR), etc.), personal computer, mobile computing device, portable computer device, media device, communication device, video processing and/or rendering device, appliance device, gaming device, electronic device, and/or as any other type of device that can be implemented to receive media content in any form of audio, video, and/or image data. According to one embodiment, computing device 12 may include hardware components and/or software components such that computing device 12 may be used to execute applications such as gaming applications, non-gaming applications, or the like. In one embodiment, computing device 12 may include a processor such as a standardized processor, a specialized processor, a microprocessor, or the like that may execute instructions stored on a processor readable storage device for performing the processes described herein.

As shown in FIG. 1, tracking system 10 may further include a capture device 20. The capture device 20 may be, for example, a camera that may be used to visually monitor one or more users 18 and 19, such that movements, postures and gestures performed by the users may be captured and tracked by the capture device 20, within a field of view, 6, of the capture device 20. Lines 2 and 4 denote a boundary of the field of view, 6.

According to one embodiment, computing device 12 may be connected to an audiovisual device 16 such as a television, a monitor, a high-definition television (HDTV), or the like that may provide visuals and/or audio to human targets 18 and 19. For example, computing device 12 may include a video adapter such as a graphics card and/or an audio adapter such as a sound card that may provide audiovisual signals to a user. The audiovisual device 16 may receive the audiovisual signals from the computing device 12 and may output visuals and/or audio associated with the audiovisual signals to users 18 and 19. According to one embodiment, audiovisual device 16 may be connected to computing device 12 via, for example, an S-Video cable, a coaxial cable, an HDMI cable, a DVI cable, a VGA cable, or the like.

In one set of operations performed by the disclosed technology, users 18, 19 view a multimedia content stream related to a current broadcast via audiovisual device 16 and computing device 12 records the users' interactions with the multimedia content stream. In one approach, a viewer, such as users 18, 19 may interact with the multimedia content stream by providing text messages, audio messages or video feeds while viewing the multimedia content stream. Text messages may include electronic mail messages, SMS messages, MMS messages or twitter messages. In one example, the viewer may provide the text messages, audio messages and video feeds via a remote control device or a mobile computing device that communicates wirelessly (e.g., WiFi, Bluetooth, infra-red, or other wireless communication means) or through a wired connection to computing system 12. In one embodiment, the remote control device or mobile computing device is synchronized to the computing device 12 that streams the multimedia content stream to the viewer so that the viewer may provide the text messages, audio messages or video feeds while viewing the multimedia content stream. In another example, a viewer may also interact with the multimedia content stream by performing movements, gestures, postures or facial expressions while viewing the multimedia content stream. The viewer's movements, gestures, postures and facial expressions may be tracked by the capture device 20 and recorded by the computing system 12 while the viewer views the multimedia content stream via the audiovisual device 16.

As described herein, a multimedia content stream can include recorded video content, video-on-demand content, television content, television programs, advertisements, commercials, music, movies, video clips, and other on-demand media content. Other multimedia content streams can include interactive games, network-based applications, and any other content or data (e.g., program guide application data, user interface data, advertising content, closed captions data, content metadata, search results and/or recommendations, etc.)

In another set of operations performed by the disclosed technology, computing device 12 generates a time synchronized commented data stream based on the viewer's interactions with the multimedia content stream. The time synchronized data stream is generated by synchronizing the data stream containing the viewer's interactions relative to a virtual start time of the multimedia content stream. In one embodiment, computing device 12 renders the viewer's commented data stream via audiovisual device 16, while simultaneously recording the viewer's interactions with the multimedia content stream. In another embodiment, computing device 12 renders commented data streams generated by other users via audiovisual device 16 to the viewer, upon the viewer's request, while simultaneously recording the viewer's interactions with the multimedia content stream. The operations performed by the computing device 12 and the capture device 20 are discussed in detail below.

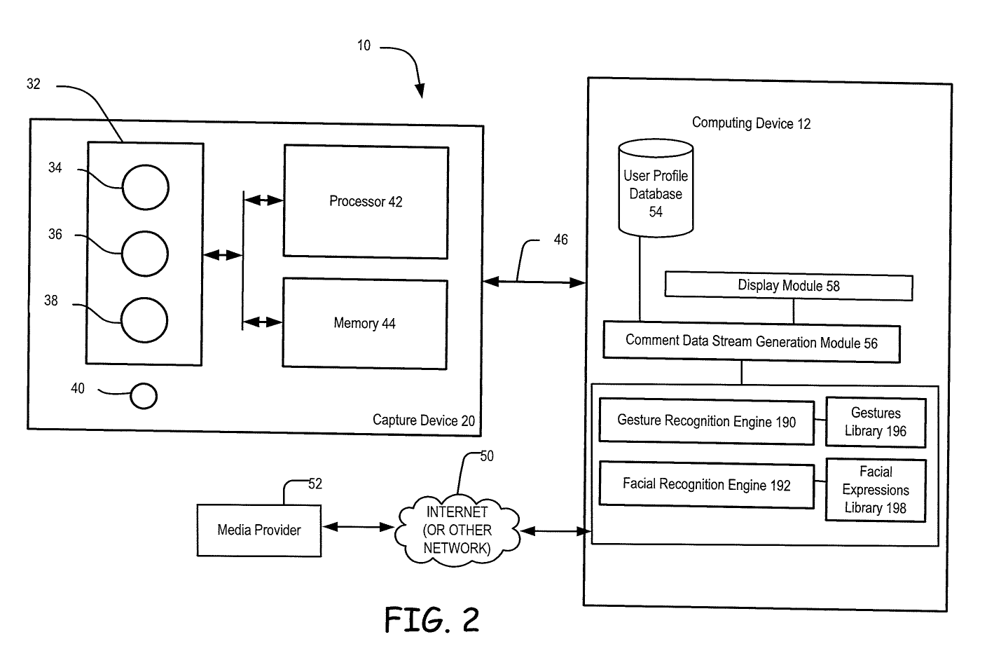

FIG. 2 illustrates one embodiment of a capture device 20 and computing device 12 that may be used in the system of FIG. 1 to perform one or more operations of the disclosed technology. According to one embodiment, capture device 20 may be configured to capture video with depth information including a depth image that may include depth values via any suitable technique including, for example, time-of-flight, structured light, stereo image, or the like. According to one embodiment, capture device 20 may organize the calculated depth information into “Z layers,” or layers that may be perpendicular to a Z-axis extending from the depth camera along its line of sight.

As shown in FIG. 2, capture device 20 may include an image camera component 32. According to one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2, the image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more targets or objects in the capture area, the pattern may become deformed in response. Such a deformation of the pattern may be captured by, for example, the 3-D camera 36 and/or the RGB camera 38 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

Capture device 20 may further include a microphone 40. The microphone 40 may include a transducer or sensor that may receive and convert sound into an electrical signal. According to one embodiment, the microphone 40 may be used to reduce feedback between the capture device 20 and the computing device 12 in the target recognition, analysis and tracking system 10. Additionally, the microphone 40 may be used to receive audio signals that may also be provided by the user while interacting with the multimedia content stream or to control applications such as game applications, non-game applications, or the like that may be executed by computing device 12.

In one embodiment, the capture device 20 may further include a processor 42 that may be in operative communication with the image camera component 32. The processor 42 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

The capture device 20 may further include a memory component 44 that may store the instructions that may be executed by the processor 42, images or frames of images captured by the 3-D camera or RGB camera, user profiles or any other suitable information, images, or the like. According to one example, the memory component 44 may include random access memory (RAM), read only memory (ROM), cache, Flash memory, a hard disk, or any other suitable storage component. As shown in FIG. 2, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 2 are housed in a single housing.

Capture device 20 may be in communication with computing device 12 via a communication link 46. The communication link 46 may be a wired connection including, for example, a USB connection, a Firewire connection, an Ethernet cable connection, or the like and/or a wireless connection such as a wireless 802.11b, g, a, or n connection. Computing device 12 may provide a clock to the capture device 20 that may be used to determine when to capture, for example, a scene via the communication link 46.

Capture device 20 may provide the depth information and images captured by, for example, the 3-D (or depth) camera 36 and/or the RGB camera 38, to computing device 12 via the communication link 46. Computing device 12 may then use the depth information and captured images to perform one or more operations of the disclosed technology, as discussed in detail below.

In one embodiment, capture device 20 captures one or more users viewing a multimedia content stream in a field of view, 6, of the capture device. Capture device 20 provides a visual image of the captured users to computing device 12. Computing device 12 performs the identification of the users captured by the capture device 20. In one embodiment, computing device 12 includes a facial recognition engine 192 to perform the identification of the users. Facial recognition engine 192 may correlate a user's face from the visual image received from the capture device 20 with a reference visual image to determine the user's identity. In another example, the user's identity may be also determined by receiving input from the user identifying their identity. In one embodiment, users may be asked to identify themselves by standing in front of the computing system 12 so that the capture device 20 may capture depth images and visual images for each user. For example, a user may be asked to stand in front of the capture device 20, turn around, and make various poses. After the computing system 12 obtains data necessary to identify a user, the user is provided with a unique identifier identifying the user. More information about identifying users can be found in U.S. patent application Ser. No. 12/696,282, “Visual Based Identity Tracking” and U.S. patent application Ser. No. 12/475,308, “Device for Identifying and Tracking Multiple Humans over Time,” both of which are incorporated herein by reference in their entirety. In another embodiment, the user's identity may already be known by the computing device when the user logs into the computing device, such as, for example, when the computing device is a mobile computing device such as the user's cellular phone. In another embodiment, the user's identity may also be determined using the user's voice print.

In one embodiment, the user's identification information may be stored in a user profile database 207 in the computing device 12. The user profile database 207 may include information about the user such as a unique identifier associated with the user, the user's name and other demographic information related to the user such as the user's age group, gender and geographical location, in one example. The user profile database 207 also includes information about the user's program viewing history, such as a list of programs viewed by the user and a list of the user's preferences. The user's preferences may include information about the user's social graph, the user's friends, friend identities, friends' preferences, activities (of the user and the user's friends), photos, images, recorded videos, etc. In one example, the user's social graph may include information about the user's preference of the groups of users that the user wishes to make his or her comments available to, while viewing a multimedia content stream.

In one set of operations performed by the disclosed technology, capture device 20 tracks movements, gestures, postures and facial expressions performed by a user, while the user views a multimedia content stream via the audio visual device 16. For example, facial expressions tracked by the capture device 20 may include detecting smiles, laughter, cries, frowns, yawns or applauses from the user while the user views the multimedia content stream.

In one embodiment, computing device 12 includes a gestures library 196 and a gesture recognition engine 190. Gestures library 196 includes a collection of gesture filters, each comprising information concerning a movement, gesture or posture that may be performed by a user. In one embodiment, gesture recognition engine 190 may compare the data captured by the cameras 36, 38 and device 20 in the form of the skeletal model and movements associated with it to the gesture filters in the gesture library 192 to identify when a user (as represented by the skeletal model) has performed one or more gestures or postures. Computing device 12 may use the gestures library 192 to interpret movements of the skeletal model to perform one or more operations of the disclosed technology. More information about the gesture recognition engine 190 can be found in U.S. patent application Ser. No. 12/422,661, “Gesture Recognition System Architecture,” filed on Apr. 13, 2009, incorporated herein by reference in its entirety. More information about recognizing gestures and postures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

Facial recognition engine 192 in computing device 12 may include a facial expressions library 198. Facial expressions library 198 includes a collection of facial expression filters, each comprising information concerning a user's facial expression. In one example, facial recognition engine 192 may compare the data captured by the cameras 36, 38 in the capture device 20 to the facial expression filters in the facial expressions library 198 to identify a user's facial expression. In another example, facial recognition engine 192 may also compare the data captured by the microphone 40 in the capture device 20 to the facial expression filters in the facial expressions library 198 to identify one or more vocal or audio responses, such as, for example, sounds of laughter or applause from a user.

In another embodiment, the user's movements, gestures, postures and facial expressions may also be tracked using one or more additional sensors that may be positioned in a room in which the user is viewing a multimedia content stream via the audiovisual device or placed, for example, on a physical surface (such as a tabletop) in the room. The sensors may include, for example, one or more active beacon sensors that emit structured light, pulsed infrared light or visible light onto the physical surface, detect backscattered light from the surface of one or more objects on the physical surface and track movements, gestures, postures and facial expressions performed by the user. The sensors may also include biological monitoring sensors, user wearable sensors or tracking sensors that can track movements, gestures, postures and facial expressions performed by the user.

In one set of operations performed by the disclosed technology, computing device 12 receives a multimedia content stream associated with a current broadcast from a media provider 52. Media provider 52 may include, for example, any entity such as a content provider, a broadband provider or a third party provider that can create structure and deliver multimedia content streams to computing device 12. The multimedia content stream may be received over a variety of networks, 50. Suitable types of networks that may be configured to support the provisioning of multimedia content services by a service provider may include, for example, telephony-based networks, coaxial-based networks and satellite-based networks. In one embodiment, the multimedia content stream is displayed via the audiovisual device 16, to the user. As discussed above, the multimedia content stream can include recorded video content, video-on-demand content, television content, television programs, advertisements, commercials, music, movies, video clips, and other on-demand media content.

In another set of operations performed by the disclosed technology, computing device 12 identifies program information related to the multimedia content stream being viewed by a viewer such as users 18, 19. In one example, the multimedia content stream may be identified as a television program, a movie, a live performance or a sporting event. For example, program information related to a television program may include the name of the program, the program's current season, episode number and the program's air date and time.

In one embodiment, computing device 12 includes a comment data stream generation module 56. Comment data stream generation module 56 records a viewer's interactions with the multimedia content stream while the viewer views the multimedia content stream. In one approach, a viewer's interactions with the multimedia content stream may include comments provided by the viewer in the form of text messages, audio messages or video feeds, while the viewer views the multimedia content stream. In another approach, a viewer's interactions with the multimedia content stream may include gestures, postures and facial expressions performed by the viewer, while the viewer views the multimedia content stream.

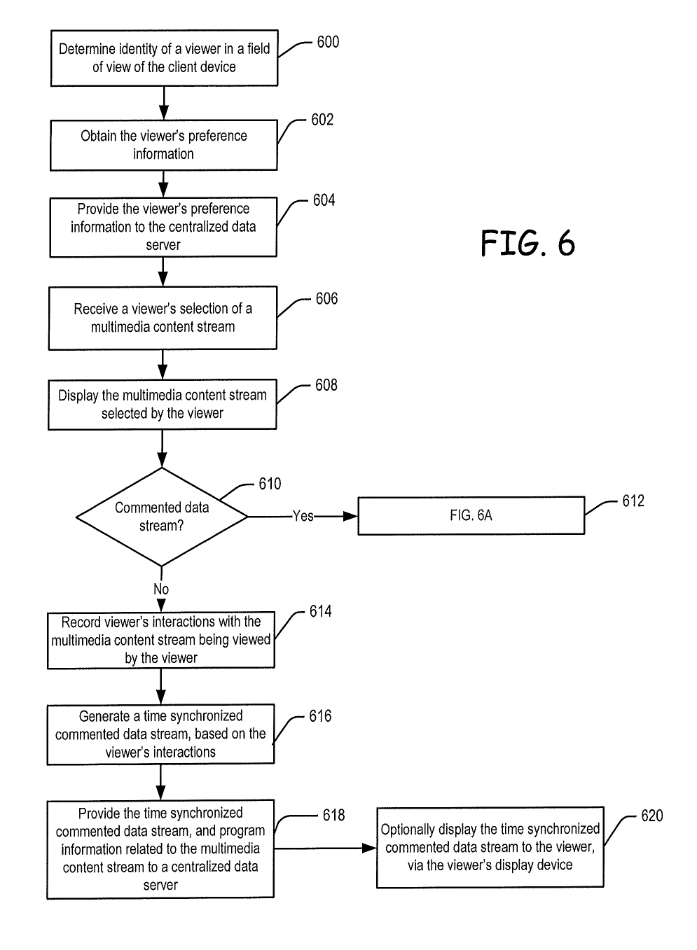

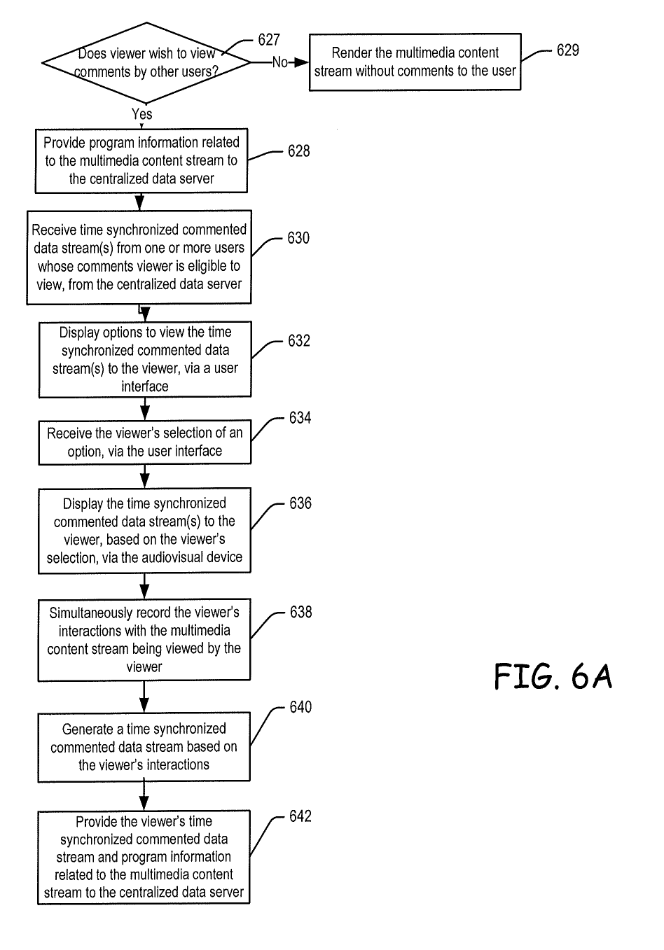

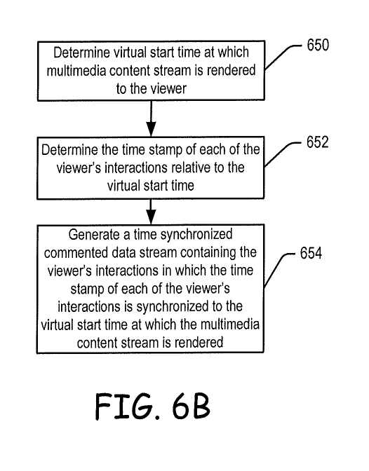

Comment data stream generation module 56 generates a time synchronized data stream based on the viewer's interactions. Comment data stream generation module 56 provides the time synchronized commented data stream and program information related to the multimedia content data stream to a centralized data server 306 (shown in FIG. 2B) for provision to other viewers. In one embodiment, the time synchronized commented data stream includes a time stamp of the viewer's interactions with the multimedia content stream that are synchronized relative to a virtual start time of the multimedia content stream. The operations performed by the computing device 12 to generate a time synchronized commented data steam is discussed in detail in FIG. 6.

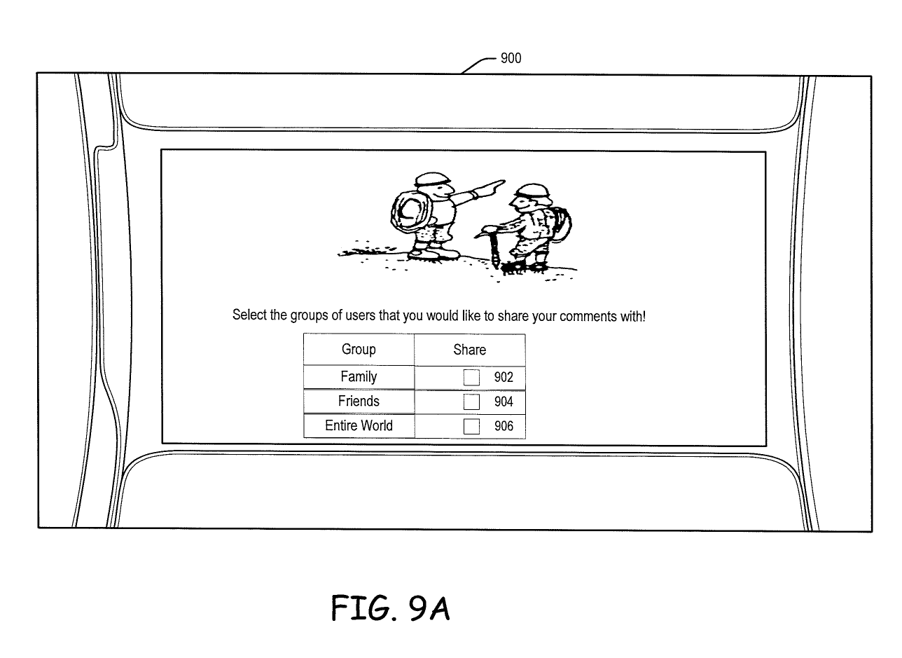

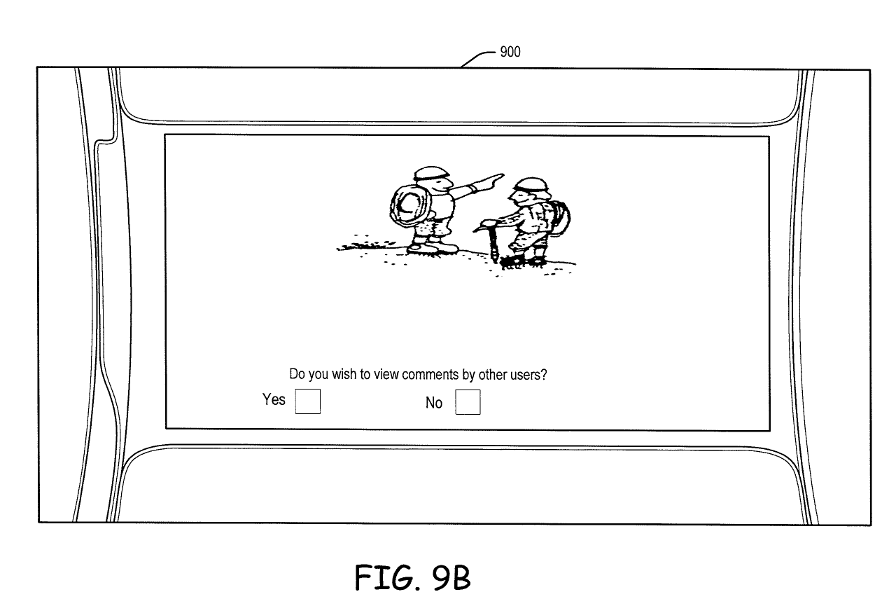

Display module 82 in computing device 12 renders the time synchronized commented data stream generated by the viewer, via audiovisual device 16. In one embodiment, the viewer may also select one or more options via a user interface in the audiovisual device 16 to view commented data streams generated by other users. The manner in which a viewer may interact with a user interface in the audiovisual device 16 is discussed in detail in FIGS. 9-11.

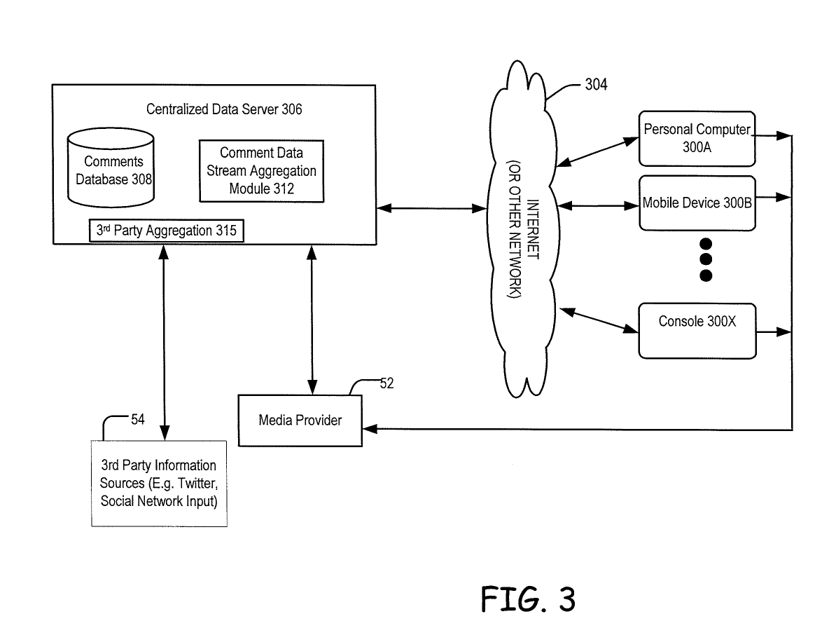

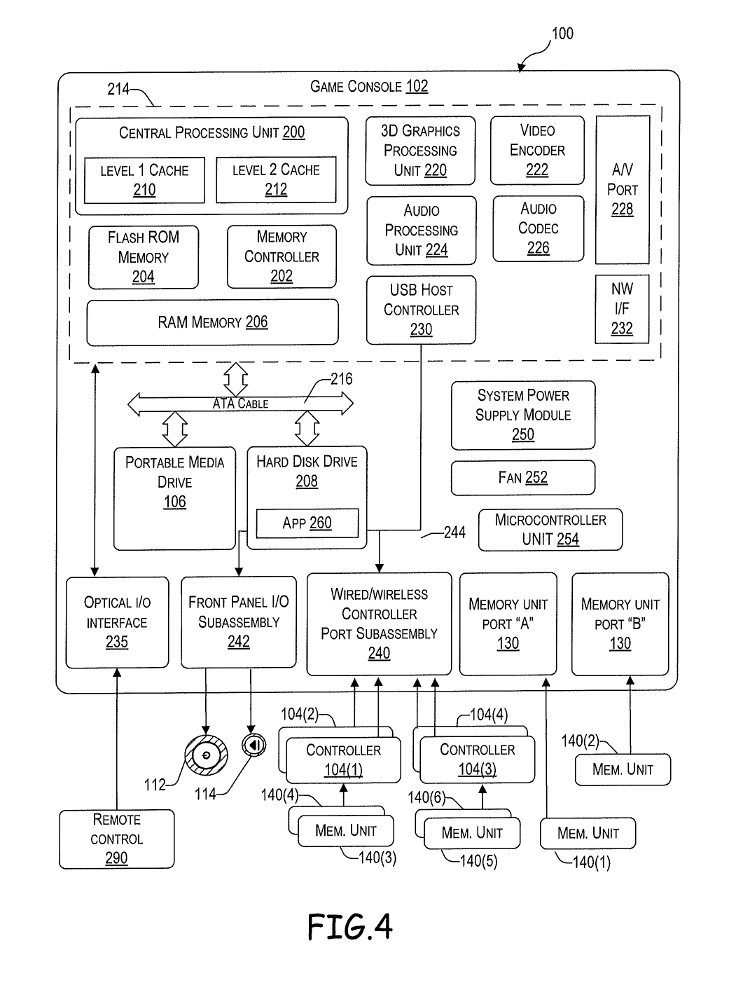

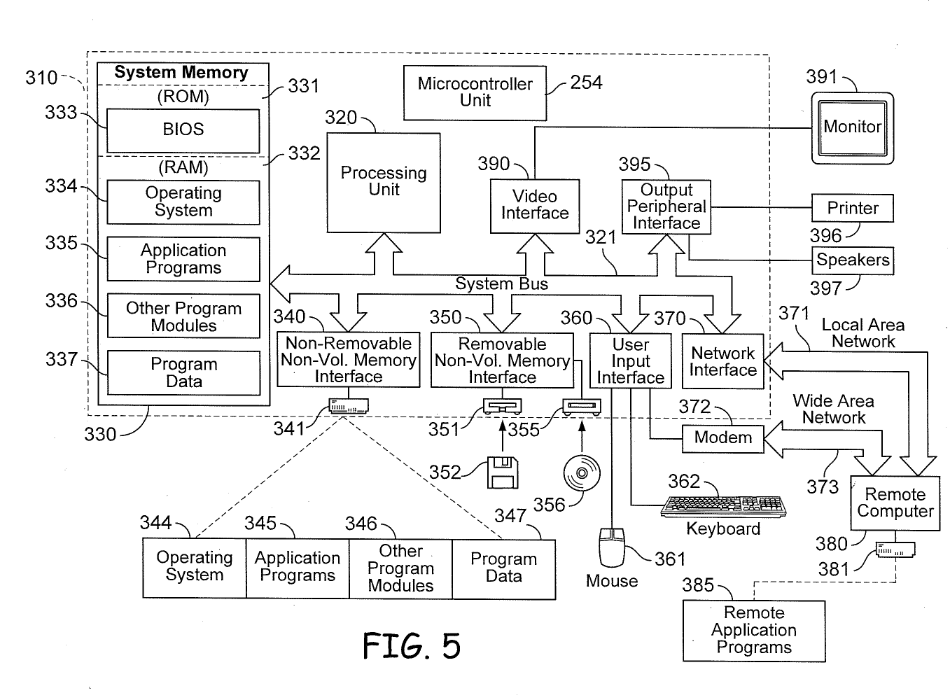

FIG. 3 illustrates an environment for implementing the present technology. FIG. 3 illustrates multiple client devices 300A, 300B . . . 300X that are coupled to a network 304 and communicate with a centralized data server 306. Centralized data server 306 receives information from and transmits information to client devices 300A, 300B . . . 300X and provides a collection of services that applications running on client devices 300A, 300B . . . 300X may invoke and utilize. Client devices 300A, 300B . . . 300X can include computing device 12 discussed in FIG. 1 or may be implemented as any of the devices described in FIGS. 4-5. For example, client devices 300A, 300B . . . 300X may include a gaming and media console, a personal computer, or a mobile device such as a cell phone, a web-enabled smart phone, a personal digital assistant, a palmtop computer or a laptop computer. Network 304 may comprise the Internet, though other networks such as LAN or WAN are contemplated.

In one embodiment, centralized data server 306 includes a comment data stream aggregation module 312. In one embodiment, comment data stream aggregation module 312 receives one or more time synchronized commented data streams from one or more users at client devices 300A, 300B . . . , 300X, program information related to the multimedia content stream and preference information related to one or more users from the client devices 300A, 300B . . . 300X and generates a report of time synchronized commented data streams related to a specific multimedia content stream viewed by one or more users. In one example, the report may be implemented as a table with fields identifying one or more users who provided comments to a specific multimedia content stream, the air date/time at which the users viewed the multimedia content stream, the time synchronized commented data stream generated by the users and the comment viewing eligibility for the specific multimedia content stream, set by the users. An exemplary illustration of such a report is illustrated in Table-1 as shown below:

TABLE 1
Report of time synchronized commented data streams
related to a specific multimedia content stream

| | | Time | |
|---|---|---|---|
| | | Synchronized | Comment |
| | | Commented | Viewing |
| User | Air Date/Time | Data Stream | Eligibility |
| User-1 | Nov. 12, 2010, | {“comment-1, | Family, Friends |
| | 9.00 PM (PST) | 00:10:05, | |
| | | comment-2, | |
| | | 00:17:07 . . .} | |
| User-2 | Nov. 15, 2010, | {“comment-1, | Family |
| | 5.00 PM (PST) | 00:11:25, | |
| | | comment-2, | |
| | | 00:20:34 . . .} | |
| User-3 | Nov. 12, 2010, | {“comment-1, | Entire World |
| | 9.00 PM (PST) | 00:12:10, | |
| | | comment-2, | |
| | | 00:30:17 . . .} | |

As shown in Table-1, the “time synchronized commented data stream” includes the user's interactions time stamped relative to a virtual start time at which the multimedia content stream is rendered to the user. The process of generating a time synchronized commented data stream is discussed in FIG. 6. “Comment viewing eligibility” refers to the groups of users that the user wishes to make his or her comments available to for viewing. In one example, the groups of users may include the user's friends, family or the entire world. In one example, the comment viewing eligibility may be obtained from the user's social graph stored in the user profile database 207. In another example, the comment viewing eligibility may also be determined by obtaining the user's preference of the groups of users that the user wishes to make his or her comments available to, directly from the user, via a user interface in the user's computing device, prior to recording the user's interactions with the multimedia content stream.

In another embodiment, centralized data server 306 also provides commented data streams generated by other users to a viewer viewing a multimedia content stream at a client device, upon the viewer's request and based on the viewer's comment viewing ability. Centralized data server 306 includes a comments database 308. Comments database 308 stores one or more time synchronized commented data streams generated by users at client devices 300A, 300B . . . 300X. Media provider 52 may include, for example, any entity such as a content provider, a broadband provider or a third party provider that can create structure and deliver a multimedia content stream directly to client devices 300A, 300B . . . , 300X or to the centralized data server 306. For example, centralized data server 306 may receive a multimedia content stream associated with a current broadcast (which may be a live, on-demand or pre-recorded broadcast) from media provider 52 and provide the multimedia content stream to one or more users at client devices 300A, 300B . . . 300X.

In one embodiment, the media provider may operate the centralized data server, or the centralized data server may be provided as a separate service by a party not associated with the media provider 52.

In another embodiment, centralized data server 306 may include data aggregation services 315 having other input sources. For example, server 306 may also receive real-time data updates from social networking or other communication services such as Twitter® feeds, Facebook® updates or voice messages provided by one or more users, from one or more third party information sources Aggregation services 315 may include authentication of the data server 306 with the third party communication services 54 and receiving updates to the third party services directly to the client devices 300A-300C. In one embodiment, aggregation service 315 can gather the real-time data updates from the third party information sources 54 and provide updates to a viewing application on the devices 300A-300C. The real-time data updates may be stored in comments database 308, in one example. One example of such an aggregation service is the Microsoft Live Service which provides social updates to the BING® search application on a mobile device executing in the viewer's mobile computing device. The viewer's mobile computing device is synchronized to the viewer's computing device, so that the viewer can view the real-time data updates via the audiovisual display connected to the viewer's computing device.

Where 3^{rd} party aggregation services are provided, the services may automatically filter any real-time data updates pertaining to the multimedia content being viewed by the user and then provide the filtered real-time data updates to the viewer, via the audiovisual display 16, while the viewer views the multimedia content stream. In another example, the application may automatically filter information updates provided to the viewer, to prevent the viewer from getting real-time data updates about the multimedia content being viewed by the viewer, when the viewer is watching a live broadcast. For example, when a user is viewing a selected media stream, social updates the user provides about the media stream may be stored for “replay” by the data stream when a later viewer watches the stream.

FIG. 4 illustrates an example of a computing device 100 that may be used to implement the computing device 12 of FIG. 1-2. The computing device 100 of FIG. 4 may be a multimedia console 100, such as a gaming console. As shown in FIG. 4, the multimedia console 100 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A graphics processing unit 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 4 shows module 214 including a USB host controller 230 and a network interface 232. USB host controller 230 is shown in communication with CPU 200 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 4, console 102 includes a controller support subassembly 240 for supporting four controllers 104(1)-104(4). The controller support subassembly 240 includes any hardware and software components needed to support wired and wireless operation with an external control device, such as for example, a media and game controller. A front panel I/O subassembly 242 supports the multiple functionalities of power button 112, the eject button 114, as well as any LEDs (light emitting diodes) or other indicators exposed on the outer surface of console 102. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

MUs 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202. A system power supply module 250 provides power to the components of gaming system 100. A fan 252 cools the circuitry within console 102.

An application 260 comprising machine instructions is stored on hard disk drive 208. When console 102 is powered on, various portions of application 260 are loaded into RAM 206, and/or caches 210 and 212, for execution on CPU 200, wherein application 260 is one such example. Various applications can be stored on hard disk drive 208 for execution on CPU 200.

Gaming and media system 100 may be operated as a standalone system by simply connecting the system to monitor 150 (FIG. 1), a television, a video projector, or other display device. In this standalone mode, gaming and media system 100 enables one or more players to play games, or enjoy digital media, e.g., by watching movies, or listening to music. However, with the integration of broadband connectivity made available through network interface 232, gaming and media system 100 may further be operated as a participant in a larger network gaming community.

FIG. 5 illustrates a general purpose computing device which can be used to implement another embodiment of computing device 12. With reference to FIG. 5, an exemplary system for implementing embodiments of the disclosed technology includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 5 illustrates operating system 334, application programs 335, other program modules 336, and program data 337.

The computer 310 may also include other removable/non-removable, volatile/nonvolatile computer storage media. By way of example only, FIG. 5 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 5, provide storage of computer readable instructions, data structures, program modules and other data for the computer 310. In FIG. 5, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 5. The logical connections depicted in FIG. 5 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 5 illustrates remote application programs 385 as residing on memory device 381. It will be appreciated that the network connections shown are exemplary and other means of establishing a communications link between the computers may be used.

The hardware devices of FIGS. 1-5 discussed above can be used to implement a system that generates one or more time synchronized commented data streams based on interactions by one or more users with multimedia content streams viewed by the users.

FIG. 6 is a flowchart describing one embodiment of a process for generating a time synchronized commented data stream based on a viewer's interactions with a multimedia content stream. In one embodiment, the steps of FIG. 6 may be performed, under the control of software, by computing device 12.

In step 600, the identity of one or more viewers in a field of view of the computing device is determined. In one embodiment, and as discussed in FIG. 2, a viewer's identity may be determined by receiving input from the viewer identifying the viewer's identity. In another embodiment, facial recognition engine 192 in computing device 12 may also perform the identification of the viewer.

In step 602, the viewer's preference information is obtained. The viewer's preference information includes one or more groups of users in the viewer's social graph that the viewer wishes to make his or her comments available to, while viewing a multimedia content stream. In one approach, the viewer's preference information may be obtained from the viewer's social graph stored in the user profile database 207. In another approach, the viewer's preference information may be obtained directly from the viewer, via a user interface in the audiovisual display 16. FIG. 9A illustrates an exemplary user interface screen for obtaining the viewer's preference information. In one example, the viewer's preference information may be obtained from the viewer each time the viewer views a multimedia content stream such as a movie or a program. In another example, the viewer's preference information may be obtained from the viewer during initial set up of the viewer's system, each time the viewer logs into the system or during specific sessions such as just before the viewer starts watching a movie or a program. In step 604, the viewer's preference information is provided to the centralized data server 306.

In step 606, a viewer selects multimedia content to view. In step 608, the multimedia content stream selected by the user is displayed to the user, via audiovisual device 16. In step 608, it is determined if the multimedia content stream selected by the user includes prior comments from other users. If the multimedia content stream includes prior comments from other users, then in step 612, steps (630-640) of the process described in FIG. 6B are performed.

If the multimedia content stream being viewed by the viewer does not include any prior comments, then in step 614, the viewer's interactions with the multimedia content stream is recorded. As discussed in FIG. 2, in one approach, the viewer's interactions with the multimedia content stream may be recorded based on text messages, audio messages or video feeds provided by the viewer, while the viewer views the multimedia content stream. In another approach, the viewer's interactions with the multimedia content stream may also be recorded based on gestures, postures or facial expressions performed by the viewer, while the viewer views the multimedia content stream.

In step 616, a time synchronized commented data stream is generated based on the viewer's interactions. The process by which a time synchronized commented data stream is generated is described in FIG. 6C.

In step 618, the time synchronized commented data stream and program information related to the multimedia content stream is provided to the centralized data server for analysis. In step 620, the time synchronized commented data stream is optionally displayed to the viewer, via the audiovisual device 16, while the viewer views the multimedia content stream.

FIG. 6A is a flowchart describing one embodiment of a process for receiving commented data streams generated by other users, upon a viewer's request to view the commented data streams. In one embodiment, the steps of FIG. 6A are performed when is it is determined that the multimedia content stream being viewed by the user includes prior comments from other users (e.g., step 610 of FIG. 6). In step 627, it is determined if the viewer wishes to view the comments from other users. For example, a viewer may have selected a multimedia content stream with prior comments, but may wish to view the multimedia content stream without the comments. FIG. 9B illustrates an exemplary user-interface screen for obtaining a viewer's request to view comments from other users. If the viewer does not wish to view comments from other users, then in step 629, the multimedia content stream is rendered to the viewer, via the audiovisual device 16, without displaying the comments from the other users.

If the viewer wishes to view comments from other users, then in step 628, program information related to the multimedia content stream is provided to the centralized data server 306. In step 630, one or more time synchronized commented data streams from one or more users whose comments the viewer is eligible to view is received from the centralized data server 306. In one example, the viewer's comment viewing eligibility related to the multimedia content stream being viewed by the viewer may be obtained from the report of time synchronized commented data streams related to a specific multimedia content stream viewed by one or more users, generated by the centralized data server 306 (e.g., as shown in Table-1).

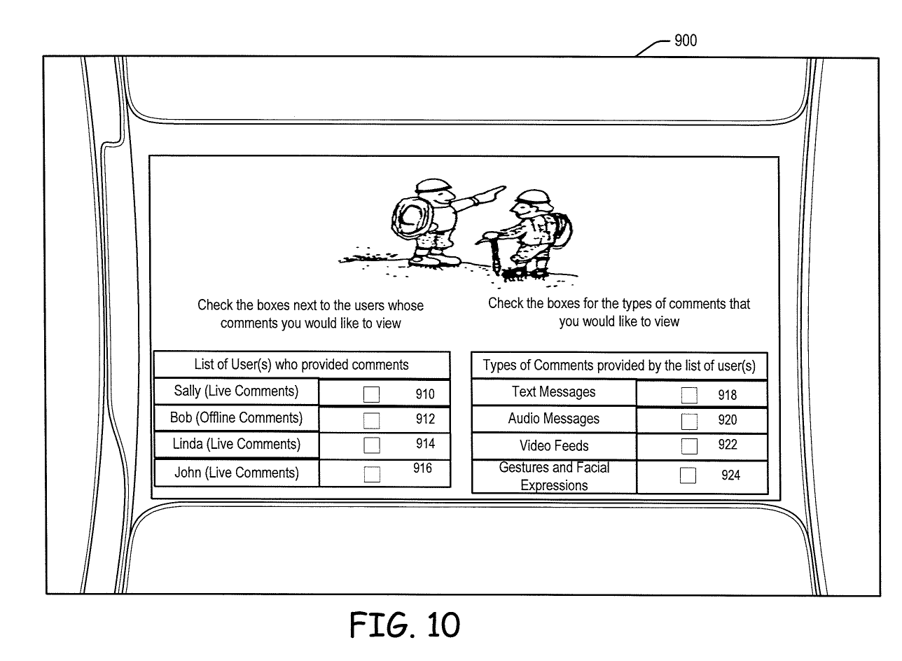

In step 632, one or more options to view the time synchronized commented data streams from the users are presented to the viewer, via a user interface in the audiovisual display 16. In one example, the options include displaying commented data streams from one or more specific users, to the viewer. In another example, the options include displaying commented data streams of a specific content type, to the viewer. The content type may include text messages, audio messages and video feeds provided by users. The content type may also include gestures and facial expressions provided by users. FIG. 10 illustrates an exemplary user-interface screen that displays one or more options to view one or more commented data streams from one or more users.

In step 634, the viewer's selection of one or more of the options is obtained, via the user interface. For example, the viewer may select to view all text messages and audio messages by users, Sally and Bob, in one embodiment. In step 636, the time synchronized commented data streams are displayed to the viewer, based on the viewer's selection, via the audiovisual device 16. In step 638, the viewer's own interactions with the multimedia content stream being viewed by the viewer are also simultaneously recorded. This allows other users the option of re-viewing the stream and allows other viewers, later in time, to view multiple sets of comments.

In step 640, a time synchronized commented data stream is generated based on the viewer's interactions. In step 642, the time synchronized commented data stream and program information related to the multimedia content stream is provided to the centralized data server for analysis.

FIG. 6B is a flowchart describing one embodiment of a process for generating a time synchronized commented data stream (e.g., more details of 616 of FIG. 6 and step 640 of FIG. 6A). In step 650, a virtual start time at which the multimedia content stream is rendered to the viewer is determined. For example, if a multimedia content stream such as a television program is aired to the viewer at 9.00 PM (PST), the virtual start time of the multimedia content stream is determined to be 0 hours, 0 minutes and 0 seconds, in one embodiment. In step 652, a time stamp of each of the viewer's interactions relative to the virtual start time is determined. For example, if a viewer's interaction with the television program being viewed by the viewer is recorded at 9.12 PM (PST), the time stamp of the viewer's interaction relative to the virtual start time is determined to be 0 hours, 12 minutes, 0 seconds. In step 654, a time synchronized commented data stream is generated. The time synchronized commented data stream includes the viewer's interactions time stamped relative to the virtual start time at which the multimedia content stream is rendered to the viewer.

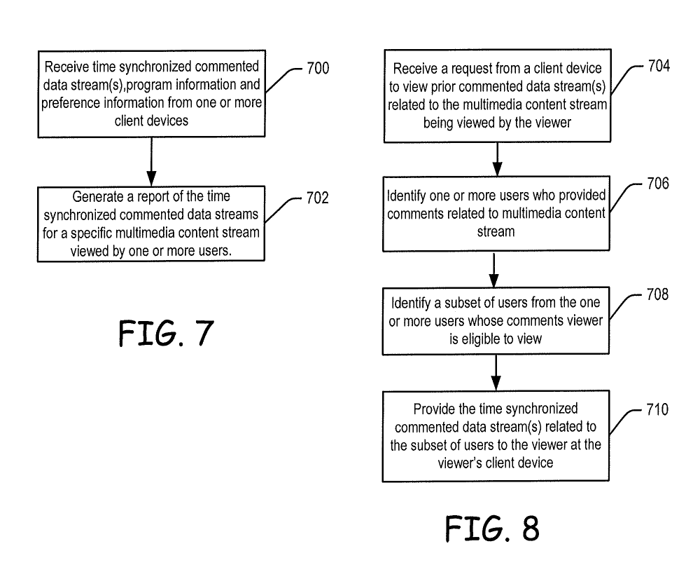

FIG. 7 is a flowchart describing one embodiment of a process for generating a report of time synchronized commented data streams related to a specific multimedia content stream viewed by one or more users. In one embodiment, the steps of FIG. 7 may be performed, under the control of software, by the comment data stream aggregation module 312 in the centralized data server 306. In step 700, one or more time synchronized commented data streams, program information related to a multimedia content stream and preference information related to one or more users is received from one or more client devices 300A, 300B, . . . 300X. In step 702, a report of time synchronized commented data streams for the specific multimedia content stream viewed by the users is generated. An exemplary illustration of a report of time synchronized commented data streams related to a specific multimedia content stream viewed by one or more users is illustrated in Table-1 above. In one embodiment, and as discussed in FIG. 2, the preference information of the one or more users is used to determine the comment viewing eligibility of the groups of users that a user wishes to make his or her comments available to, for viewing.

FIG. 8 is a flowchart describing one embodiment of a process for providing commented data streams generated by other users to a viewer based on the viewer's comment viewing eligibility. In one embodiment, the steps of FIG. 8 may be performed, under the control of software, by the centralized data server 306. In step 704, a request from one or more client devices 300A, 300B . . . 300X is received to view one or more prior commented data streams related to the multimedia content being viewed by the viewer. For example, step 704 may be performed upon receiving a request from one or more client devices at step 628 of FIG. 6A. In step 706, one or more users who provided comments related to the multimedia content stream are identified. In one example, the one or more users may be identified by referring to the report of time synchronized commented data streams related to a specific multimedia content stream viewed by one or more users (e.g., as shown in Table-1). In step 708, a subset of users whose comments the viewer is eligible to view are identified. In one example, the subset of users may be identified by referring to the “comment viewing eligibility” field shown in Table-1. For example, a viewer is eligible to view the comments provided by a specific user, if the viewer is in one or more of the groups of users listed in the “comment viewing eligibility” field provided by the specific user. In step 710, the time synchronized commented data streams related to the subset of users is provided to the viewer, at the viewer's client device.

FIG. 9A illustrates an exemplary user-interface screen for obtaining a viewer's preference information prior to recording the viewer's interaction with the multimedia content stream. As discussed above, the viewer's preference information includes one or more groups of users that the viewer wishes to make his or her comments available to for viewing. In one example, the groups of users may include the viewer's friends, family or the entire world. In the exemplary illustration of FIG. 9A, the viewer may be presented with text such as, “Select the groups of users that you would like to share your comments with!” In one example, the viewer may check one or more of the boxes, 902, 904 or 906 to select one or more groups of users.

In another example, the friends may be part of a user's social grid and defined into layers of relative closeness, such as specified in U.S. patent application Ser. No. ______, filed Dec. 17, 2010, entitled GRANULAR METADATA FOR DIGITAL CONTENT, inventors Kevin Gammill, Stacey Law, Scott Porter, Alex Kipman, Avi Bar-Ziev, Kathryn Stone-Perez fully incorporated herein by reference.

FIG. 9B illustrates an exemplary user-interface screen for obtaining a viewer's request to view comments from other users. In the exemplary illustration of FIG. 9B, the viewer may be presented with text such as, “Do you wish to view comments by other users?” In one example, the viewer's request may be obtained when the viewer selects one of the boxes, “Yes” or “No”.

FIG. 10 illustrates an exemplary user-interface screen that displays one or more options to a viewer to view time synchronized commented data streams related to a multimedia content stream. In one example, a viewer may view commented data streams from one or more specific users by selecting one or more of the boxes, 910, 912 or 914. As further illustrated, the time synchronized commented data streams from the users may be categorized as “Live” or “Offline”, in one example. As used herein, a commented data stream by a user is categorized as “Live” if the user provided comments during a live airing of a program, and “Offline” if the user provided comments during a recording of the program. The “Live” or “Offline” categorizations of a commented data stream may be derived based on the air time/date of the show, from the report of time synchronized commented data streams generated by the centralized data server 306. It is to be appreciated that the “Live” and “Offline” characterizations of time synchronized commented data streams provides the viewer with the option of viewing only comments from users who watched the show live versus users who watched a recording of the show. As further illustrated in FIG. 10, the viewer may select one or more of the boxes, 910, 912, 914 or 916 to select one or more groups of users. In another example, the viewer may also view time synchronized commented data streams of a particular content type such as text messages, audio messages, video feeds, gestures or facial expressions provided by one or more users. The viewer may select one or more of the boxes, 918, 920, 922 or 924 to view time synchronized commented data streams of a particular content type, by one or more users. In another example, the viewer may also view real-time data updates provided to the viewer's mobile computing device from third party information sources 54, via the audiovisual device 16, while viewing the multimedia content stream. The viewer may also choose to not view any commented data streams from any of the users, in another example.

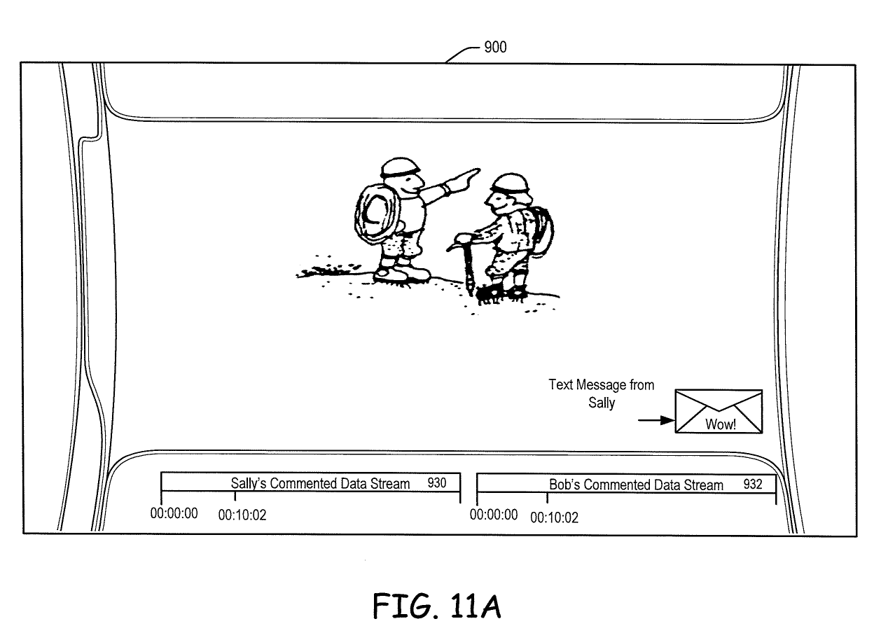

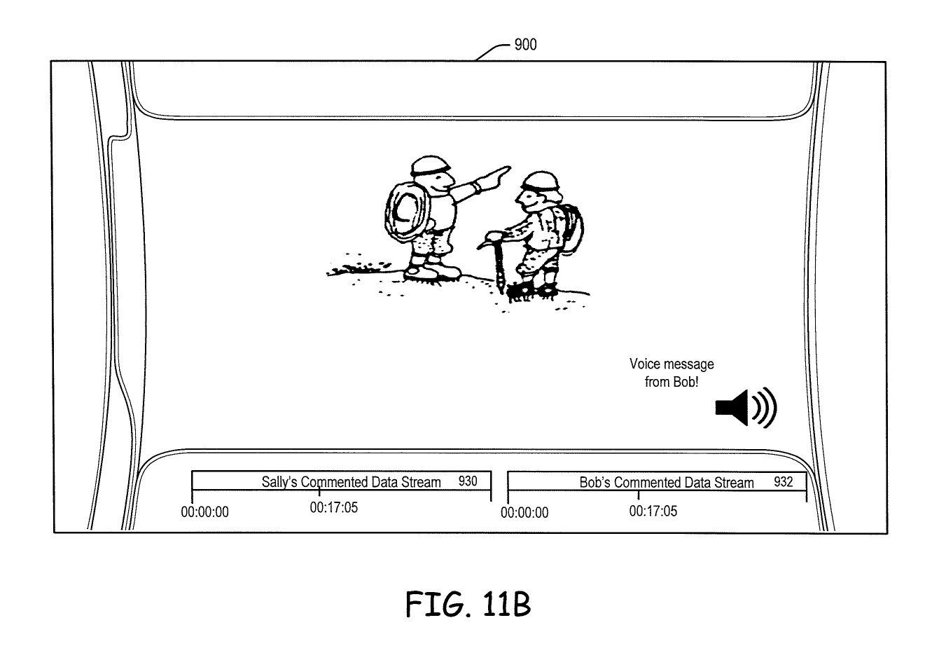

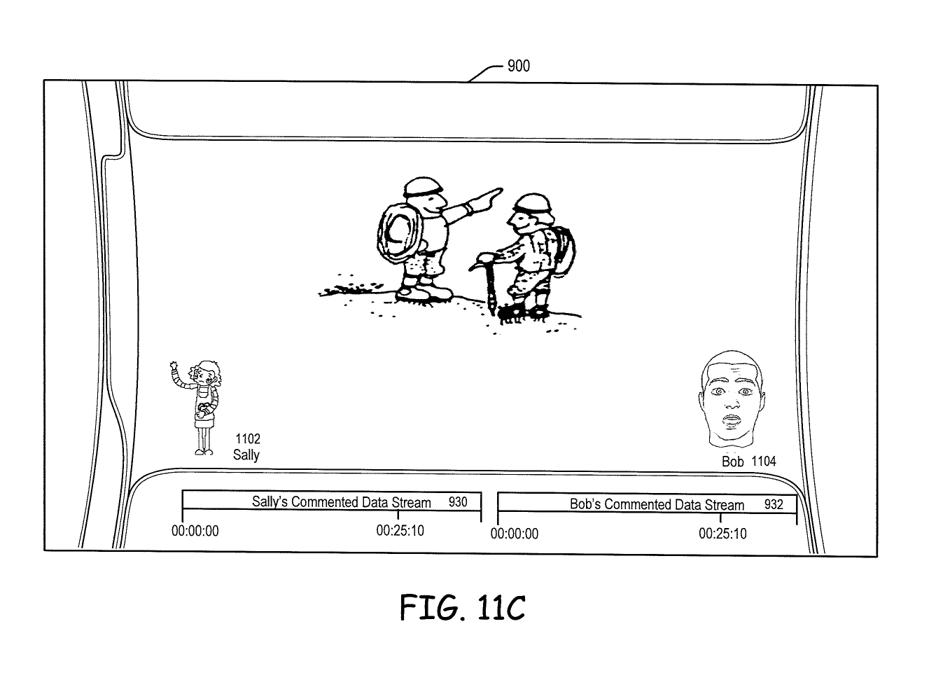

FIGS. 11A, 11B and 11C illustrate exemplary user-interface screens in which one or more time synchronized commented data streams related to a multimedia content stream are displayed to a viewer. In the exemplary illustration, the time synchronized commented data streams 930, 932 include comments by users Sally and Bob respectively. As further illustrated, the time synchronized commented data streams 930, 932 are synchronized relative to a virtual start time of the multimedia content stream. The commented data streams 930, 932 re-create for the viewer, an experience of watching the multimedia content live with the other users, while the viewer views the multimedia content stream.

FIG. 11A illustrates an embodiment of the technology wherein a text message appears at time point 10:02 in the data stream. The text message may have been sent by Sally at that time in viewing the content and is thus recreated as a text on the screen of the viewing user. FIG. 11B illustrates a voice message or voice comment played over an audio output. It should be recognized that the audio output need not have any visual indicator, or may include a small indictor as illustrated in FIG. 11b to indicate that the audio is not part of the stream.

FIG. 11C illustrates providing a user avatar 1102 or video recorded clip 1104 of Sally and Bob. Where the capture device and tracking system discussed above is utilized, an avatar which mimics the movements and audio of a user may be generated by the system. In addition, a video clip 1104 of the user may be recorded by the capture device and tracking system. All or portions of the commenting user may be displayed. For example, the whole body image is displayed in Sally's avatar 1102, but just Bob's face is displayed in Bob's recording to illustrate Bob is sad at this portion of the content. Either or both of these representations of the user may be provided in the user interface of the viewing user. Whether the commenting user is displayed as an avatar having a likeness of the user, an avatar representing something other than the user, or a video of the commenting user is displayed, may be configurable by the commenting user or the viewing user. Further, although only two commenting users are illustrated, any number of commenting users may be presented in the user interface. In addition, the size of the presentation of the avatar or video may also vary from a relatively small section of the display to larger portions of the display. The avatar or video may be presented in a separate window or overlaid on the multimedia content.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the technology be defined by the claims appended hereto.

What is claimed is:

1. A computer-implemented method for generating a time synchronized commented data stream based on a viewer's interaction with a multimedia content stream, comprising the computer-implemented steps of:
identifying a viewer in a field of view of a capture device connected to a computing device;
receiving a selection from the viewer of a multimedia content stream to view, via the computing device;
recording the viewer's interactions with the multimedia content stream being viewed by the viewer;
generating a time synchronized commented data stream based on the viewer's interactions; and
responsive to a request from the viewer, displaying one or more time synchronized commented data streams related to the multimedia content stream being viewed by the viewer, via an audiovisual device connected to the computing device.

2. The computer-implemented method of claim 1, wherein the viewer's interactions comprise text messages, audio messages and video feeds provided by the viewer, while the viewer views the multimedia content stream.

3. The computer-implemented method of claim 1, wherein the viewer's interactions comprise gestures, postures and facial expressions performed by the viewer, while the viewer views the multimedia content stream.

4. The computer-implemented method of claim 1, further comprising obtaining the preference information related to the multimedia content stream, wherein the preference information includes one or more groups of users in a social graph of the viewer that are eligible to view the viewer's interactions with the multimedia content stream.

5. The computer-implemented method of claim 1, wherein generating the time synchronized commented data stream further comprises:
determining a virtual start time at which the multimedia content stream is rendered to the viewer;
determining a time stamp of viewer interactions relative to the virtual start time; and
generating a time synchronized commented data stream, the time synchronized commented data stream includes the viewer's interactions time stamped relative to the virtual start time at which the multimedia content stream is rendered to the viewer.

6. The computer-implemented method of claim 1, wherein displaying the one or more time synchronized commented data streams further comprise:
obtaining viewer comment viewing eligibility related to the multimedia content stream being viewed by the viewer;
presenting one or more options to view the one or more time synchronized commented data streams, via a user interface, based on viewer comment viewing eligibility;
obtaining a selection of the one or more options, from the viewer, via the user interface; and
displaying the one or more time synchronized commented data streams to the viewer, based on a viewer's selection.

7. The computer-implemented method of claim 6, wherein presenting the one or more options and obtaining a selection of the one or more options further comprises:
displaying one or more time synchronized commented data streams from one or more specific users, to the viewer, based on a viewer's selection.

8. The computer-implemented method of claim 6, wherein presenting the one or more options and obtaining a selection of the one or more options further comprises:
displaying one or more time synchronized commented data streams of a specific content type to the viewer, based on the viewer's selection, wherein the content type includes text messages, audio messages, video feeds, gestures and facial expressions provided by one or more users.

9. The computer-implemented method of claim 1, further comprising rendering the time synchronized commented data stream to the viewer, via the audiovisual device, while simultaneously recording the viewer's interactions with the multimedia content stream.

10. The computer-implemented method of claim 1, wherein displaying the one or more time synchronized commented data streams further comprise:
simultaneously recording the viewer's interactions with the multimedia content stream while rendering the one or more time synchronized commented data streams to the viewer.

11. The computer-implemented method of claim 1, wherein:
the receiving the viewer's selection of the multimedia content stream comprises displaying the multimedia content stream to the viewer via an audiovisual device connected to the computing device;
the recording the viewer's interactions with the multimedia content stream comprises recording text messages, audio messages and video feeds provided by the viewer, while the viewer views the multimedia content stream;
the recording the viewer's interactions with the multimedia content stream comprises recording gestures, postures and facial expressions performed by the viewer, while the viewer views the multimedia content stream;
the generating the time synchronized commented data stream comprises determining a time stamp of the viewer's interactions relative to a virtual start time at which the multimedia content stream is rendered to the viewer, wherein the time synchronized commented data stream includes the viewer's interactions time stamped relative to the virtual start time at which the multimedia content stream is rendered to the viewer;
the displaying one or more time synchronized commented data streams comprises simultaneously recording the viewer's interactions with the multimedia content stream while rendering the one or more time synchronized commented data streams to the viewer.

12. One or more processor readable storage devices having processor readable code embodied on said one or more processor readable storage devices, the processor readable code for programming one or more processors to perform a method comprising:
receiving one or more time synchronized commented data streams related to one or more users;
generating a report of time synchronized commented data streams for a multimedia content stream viewed by the one or more users;
receiving a request from a viewer to view the one or more time synchronized commented data streams related to the one or more users; and
providing the one or time synchronized commented data streams related to the one or more users, to the viewer.

13. One or more processor readable storage devices according to claim 12, wherein providing the one or time synchronized commented data streams related to the one or more users further comprises:
identifying the one or more users who provided comments related to the multimedia content stream being viewed by the viewer, utilizing the report;
identifying a subset of users from the one or more users whose comments the viewer is eligible to view, based on a comment viewing eligibility related to the one or more users, wherein the comment viewing eligibility includes one or more groups of users in a social graph related to the one or more users that the one or more users wish to make comments provided by the one or more users available to, for viewing; and
providing the one or time synchronized commented data streams related to the subset of users, to the viewer.

14. One or more processor readable storage devices according to claim 12, further comprising:
receiving program information related to the multimedia content stream;
receiving preference information related to the one or more users; and
generating the report of time synchronized commented data streams for the multimedia content stream viewed by the one or more users based on the program information and the preference information.

15. One or more processor readable storage devices according to claim 14, wherein the preference information is utilized to determine one or more groups of users in the social graph related to the one or more users that the one or more users wish to make comments provided by the one or more users available to, for viewing.

16. A system for generating a time synchronized commented data stream based on a viewer's interaction with a multimedia content stream, comprising:
one or more client devices in communication with a centralized data server via a communications network, wherein the one or more client devices include instructions causing a processing device in the client devices to:
record interactions from one or more viewers with a multimedia content stream being viewed by the one or more viewers;
generate one or more time synchronized commented data streams based on the interactions;
provide the time synchronized commented data streams to the centralized data server;
receive a selection from the one or more viewers to view multimedia content;
determine whether a commented data stream exists for the multimedia content; and
upon selection by the one or more viewers to view the commented data stream, present the multimedia content with the commented data stream.

17. The apparatus of claim 16, wherein:
the one or more client devices record visual and audio interactions of the one or more viewers in the commented data stream.

18. The apparatus of claim 17, further comprising:
an audiovisual device connected to the one or more client devices, the audiovisual device displays visual and audio interactions of other users in commented data streams with the multimedia content stream being viewed by the viewer.

19. The apparatus of claim 18, further comprising:
a depth camera connected to the one or more client devices, the depth camera tracks the interactions from the one or more viewers based on movements, gestures, postures and facial expressions performed by the one or more viewers in a field of view of the one or more client devices.

20. The apparatus of claim 16, further comprising:
a mobile computing device connected to the one or more client devices, wherein the mobile computing device receives the interactions from the one or more viewers, and wherein the mobile computing device is synchronized to the one or more client devices streaming the multimedia content stream to the viewers.
